(19) United States
(12) Patent Application Publication
(10) Pub. No.: US 2025/0301268 A1
(43) Pub. Date: Sep. 25, 2025

(54) ACOUSTIC PORT GUARD AND IN-EAR ACOUSTIC PORT

(71) Applicant: Starkey Laboratories, Inc., Eden Prairie, MN (US)

(72) Inventor: Viktor Klymko, Minneapolis, MN (US)

(21) Appl. No.: 19/068,376

(22) Filed: Mar. 3, 2025

Related U.S. Application Data
(60) Provisional application No. 63/567,774, filed on Mar. 20, 2024.

(51) Int. Cl. H04R 25/00

(52) U.S. Cl. CPC H04R 25/654; H04R 25/656

(57) ABSTRACT

Embodiments herein relate to ear-wearable devices having acoustic port guards. In an embodiment, an ear-wearable device is included having a receiver, an acoustic channel wall defining an acoustic channel between the receiver and an acoustic channel opening, an acoustic port guard disposed at a device opening. The acoustic port guard is included having a first ring structure including a first ring portion and an insertion portion, wherein the insertion portion is configured to be inserted into the device opening. The acoustic port guard can include a plurality of ribs connected to the first ring structure with each of the plurality of ribs defining an outer portion extending beyond an outer radius of the first ring structure. Other embodiments are also included herein.

This application claims the benefit of U.S. Provisional Application No. 63/567,774, filed Mar. 20, 2024, the content of which is incorporated herein by reference in its entirety.

### FIELD

Embodiments herein relate to ear-wearable devices and more particularly to ear-wearable devices having acoustic port guards.

### BACKGROUND

Modern hearing assistance devices, such as hearing aids, are electronic instruments worn in or around the ear that compensate for hearing losses by amplifying sound. Hearing aids include an enclosure or housing with one or more openings for a microphone that senses sound, hearing assistance device electronics including processing electronics, and a speaker or receiver to play processed sound for the wearer. One of the recurring problems with such devices is the accumulation of foreign matter interfering with the performance of the internal components. The accumulation of foreign material in hearing assistance devices reduces both the overall lifetime of the device and the maximum time the device can perform adequately between cleanings.

### SUMMARY

In a first aspect, an ear-wearable device can be included having a receiver, an acoustic channel wall defining an acoustic channel between the receiver and an acoustic channel opening, an acoustic port guard disposed at a device opening. The acoustic port guard can be included having a first ring structure including a first ring portion and an insertion portion, wherein the insertion portion can be configured to be inserted into the device opening. The acoustic port guard can include a plurality of ribs connected to the first ring structure, each of the plurality of ribs defining an outer portion extending beyond an outer radius of the first ring structure.

In a second aspect, in addition to one or more of the preceding or following aspects, or in the alternative to some aspects, the acoustic port guard can include a second ring structure.

In a third aspect, in addition to one or more of the preceding or following aspects, or in the alternative to some aspects, the plurality of ribs connects the first ring structure to the second ring structure, and wherein the second ring structure can be positioned coaxially to the first ring structure.

In a fourth aspect, in addition to one or more of the preceding or following aspects, or in the alternative to some aspects, the second ring structure can be spaced a fixed axial distance from the first ring structure.

In a fifth aspect, in addition to one or more of the preceding or following aspects, or in the alternative to some aspects, can include a third ring structure disposed between the first ring structure and the second ring structure.

In a sixth aspect, in addition to one or more of the preceding or following aspects, or in the alternative to some aspects, the insertion portion can be configured to be inserted into the acoustic channel up to a proximal face of the first ring portion.

In a seventh aspect, in addition to one or more of the preceding or following aspects, or in the alternative to some aspects, wherein each of the plurality of ribs defines a plurality of spiked portions.

In an eighth aspect, in addition to one or more of the preceding or following aspects, or in the alternative to some aspects, the outer portion includes at least one of the plurality of spiked portions.

In a ninth aspect, in addition to one or more of the preceding or following aspects, or in the alternative to some aspects, the acoustic port guard includes at least three and at most eight ribs.

In a tenth aspect, in addition to one or more of the preceding or following aspects, or in the alternative to some aspects, the acoustic port guard defines an open central channel, wherein the open central channel defines at least 20% of a cross-sectional area of the acoustic channel.

In an eleventh aspect, in addition to one or more of the preceding or following aspects, or in the alternative to some aspects, the acoustic port guard can include one of the group consisting of an oleophobic coating, a hydrophilic coating, and a hydrophobic coating.

In a twelfth aspect, in addition to one or more of the preceding or following aspects, or in the alternative to some aspects, the insertion portion can be configured to conform to the acoustic channel wall.

In a thirteenth aspect, in addition to one or more of the preceding or following aspects, or in the alternative to some aspects, the ear-wearable device can further include a housing. A housing acoustic channel wall defines at least a housing portion of the acoustic channel. The housing encloses the receiver. An earbud is configured to fit over at least a portion of the housing. The earbud can include an earbud inner wall, wherein the earbud inner wall defines an earbud portion of the acoustic channel. The device opening can be defined in the earbud at a distal end of the earbud portion of the acoustic channel.

In a fourteenth aspect, in addition to one or more of the preceding or following aspects, or in the alternative to some aspects, wherein each of the plurality of ribs extend above the insertion portion by a rib height, wherein the rib height can be 0.5 millimeter or greater.

In a fifteenth aspect, an acoustic port guard for an ear-wearable device can be included having a first ring structure including a first ring portion and an insertion portion. The insertion portion can be configured to be inserted into an acoustic channel of the ear-wearable device through a device opening of the ear-wearable device. A second ring structure can include a second ring portion. The second ring portion defines an acoustic channel opening of the ear-wearable device. The acoustic port guard can include a plurality of ribs connected to the first ring structure and the second ring structure. Each of the plurality of ribs can define an outer portion extending beyond an outer radius of the first ring structure and the second ring structure.

In a sixteenth aspect, in addition to one or more of the preceding or following aspects, or in the alternative to some aspects, the second ring structure can be spaced a fixed axial distance from the first ring structure.

In a seventeenth aspect, in addition to one or more of the preceding or following aspects, or in the alternative to some aspects, the insertion portion can be configured to be inserted into the acoustic channel up to a proximal face of the first ring portion.

In an eighteenth aspect, in addition to one or more of the preceding or following aspects, or in the alternative to some aspects, wherein each of the plurality of ribs defines a plurality of spiked portions.

In a nineteenth aspect, in addition to one or more of the preceding or following aspects, or in the alternative to some aspects, the acoustic port guard defines an open central channel, wherein the open central channel defines at least 20% of a cross-sectional area of the acoustic channel.

In a twentieth aspect, a method of repelling foreign material from an ear-wearable device can include providing an acoustic port guard. The acoustic port guard can include a first ring structure having a first ring portion and an insertion portion, and a plurality of ribs connected to the first ring structure, each of the plurality of ribs defining a plurality of spiked portions configured to extend beyond an outer radius of the first ring structure. The method can include inserting the insertion portion of the acoustic port guard into an acoustic channel of the ear-wearable device up to a proximal face of the first ring portion, wherein the plurality of ribs blocks foreign material from entering the acoustic channel.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a perspective view of an ear-wearable device is shown in accordance with various embodiments herein.

FIG. 2 is a perspective view of a receiver assembly and earbud in accordance with various embodiments herein.

FIG. 3 is a cross-sectional view of the receiver assembly and earbud of FIG. 2 about section 3-3, including an acoustic port guard, in accordance with various embodiments herein.

FIG. 4 is a schematic view of an in-the-ear style custom ear-wearable device, including an acoustic port guard, in accordance with various embodiments herein.

FIG. 5 is a perspective view of an acoustic port guard in accordance with various embodiments herein.

FIG. 6 is a front view of the acoustic port guard of FIG. 5 in accordance with various embodiments herein.

FIG. 7 is a top view of the acoustic port guard of FIG. 5 in accordance with various embodiments herein.

FIG. 8 is a top view of an alternate configuration of an acoustic port guard in accordance with various embodiments herein.

FIG. 9 is a cross-sectional view of an acoustic port guard disposed in an ear-wearable device in accordance with various embodiments herein.

FIG. 10 is a cross-sectional view of an alternate configuration of an acoustic port guard in accordance with various embodiments herein.

FIG. 11 is a schematic block diagram of an ear-wearable device that is shown with various components of an ear-wearable device in accordance with various embodiments herein.

While embodiments are susceptible to various modifications and alternative forms, specifics thereof have been shown by way of example and drawings and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Ear-wearable devices are vulnerable to the accumulation of foreign matter interfering with the performance of the internal components. For instance, the performance of audio components placed in an ear canal tends to suffer when foreign matter, such as wax, liquid, skin cells, dust, or dirt, plugs the acoustic ports. Blockage of the acoustic ports can lead to dramatic change in acoustic impedance and an effective reduction in device output. For this reason, it is desirable for an ear-wearable device to be able to deflect foreign material and minimize the amount of foreign material entering an acoustic channel.

In various embodiments, an ear-wearable device can include a receiver and an acoustic channel wall defining an acoustic channel between the receiver and an acoustic channel opening. The ear-wearable device can further include an acoustic port guard disposed at a device opening of the ear-wearable device. The acoustic port guard can include a first ring structure having a first ring portion and an insertion portion, wherein the insertion portion is configured to be inserted into the device opening. The acoustic port guard can further include a plurality of ribs connected to the first ring structure. Each rib defines an outer portion configured to extend beyond an outer radius of the first ring structure. In various embodiments, the outer portion is configured to extend beyond an outer radius of the second ring structure. Portions of the rib can extend away from the first ring structure in a direction opposite from the insertion portion, in some embodiments. In various embodiments, each of the plurality of ribs further defines a plurality of spiked portions. The outer portion may include one of the plurality of spiked portions. In various embodiments, the acoustic port guard is configured to prevent foreign material from entering the acoustic channel of the ear-wearable device. The rib structures can deflect foreign matter before it has an opportunity to enter the acoustic channel.

In some embodiments, the rib structures are flexible, such as an elastomeric material, allowing the rib structures to flex and be brushed off to free foreign matter. In various embodiments, the rib structures easily shed the foreign matter when the ear-wearable device is moved or shaken, such as when the ear-wearable device is removed from the user's ear.

The spiked portions of the ribs can alternatively be referred to as protrusions, curved protrusions, or lobes.

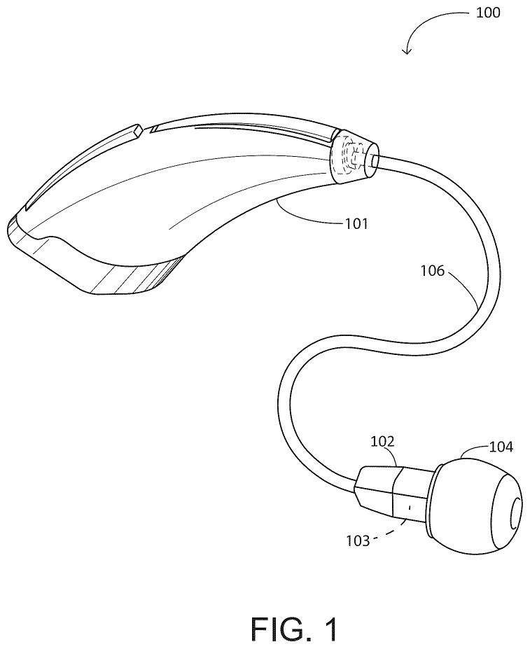

### Ear-Wearable Device (FIG. 1)

Referring now to FIG. 1, a perspective view of an ear-wearable device is shown in accordance with various embodiments herein. In various embodiments, the ear-wearable device 100 can include an external unit 101, a receiver housing 102, an earbud 104 covering a portion of the receiver housing 102, and a cable 106 connecting the external unit 101 with the receiver housing 102. The external unit 101 may be worn outside of the ear canal, such as over the user's ear, behind the user's ear, clipped to a user's clothing, or many other locations.

The term “ear-wearable device” shall refer to devices worn on or in the ear. Though not required, in some embodiments, ear-wearable devices can aid a person with hearing, such as a hearing assistance devices or hearing aids. Examples of hearing assistance devices are devices that can aid a person with impaired hearing or that can produce sounds, optimized sounds, or processed sound for persons with normal hearing. Hearing assistance devices herein can include hearables (e.g., wearable earphones, headphones, earbuds, virtual reality headsets), hearing aids (e.g., hearing instruments), cochlear implants, and bone-conduction devices, for example. Hearing assistance devices that are also custom ear-wearable devices include, but are not limited to, in-the ear (ITE), in-the-canal (ITC), invisible-in-canal (IIC), or completely-in-the-canal (CIC) type hearing assistance devices, or some combination of the foregoing devices. Ear-wearable devices can also be used to block sound or even be unrelated to hearing. In some embodiments herein, an ear-wearable device may also take the form of a piece of jewelry, or a component of frames of glasses, which may be attached to the head on or about the ear. Ear-wearable devices can be worn within the ear in some embodiments.

Components of an ear-wearable device herein can include a control circuit, digital signal processor (DSP), memory (such as non-volatile memory), power management circuitry, a data communications bus, one or more communication devices (e.g., a radio, a near-field magnetic induction device), one or more antennas, one or more microphones, and various sensors as described in greater detail below. More advanced hearing assistance devices can incorporate a long-range communication device, such as a Bluetooth® transceiver or other type of radio frequency (RF) transceiver. The ear-wearable device can define a battery compartment into which a battery can be disposed to provide power to the device. These components can be divided between the external unit 101, other external devices, and the receiver housing 102. An external unit 101 can include input devices such as buttons or pads to control the ear-wearable device.

The receiver housing 102 encloses a receiver 103, also referred to as a receiver speaker or a speaker. The receiver housing 102 is sized and shaped to fit within a user's ear canal. The ear-wearable device 100 can be referred to as a receiver-in-canal (RIC) system. Sound is output from the receiver housing 102 to the user's ear canal. The cable 106 can include one or more electrical conductors and provide electrical communication between components inside of the external unit 101 and components inside of the receiver housing 102. The cable 106 provides an electrical signal from the external unit to drive the receiver to produce sound.

The ear-wearable device 100 shown in FIG. 1 is a behind-the-ear (BTE) type device and thus the receiver is designed to be placed within the ear canal. However, it will be appreciated that many different form factors for ear-wearable devices are contemplated herein. As such, ear-wearable devices herein can include, but are not limited to, behind-the-ear (BTE), in-the ear (ITE), in-the-canal (ITC), invisible-in-canal (IIC), receiver-in-canal (RIC), receiver in-the-ear (RITE) and completely-in-the-canal (CIC) type ear-wearable devices. Aspects of ear-wearable devices and functions thereof are described in U.S. Pat. No. 9,848,273; U.S. Publ. patent application No. 20180317837; and U.S. Publ. patent application No. 20180343527, the content of each of which is herein incorporated by reference in their entirety.

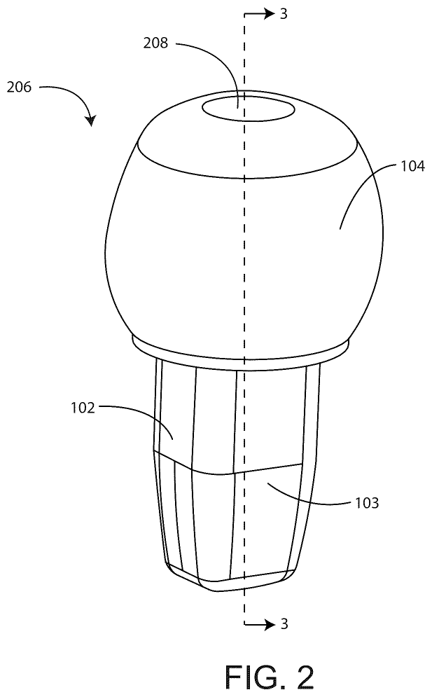

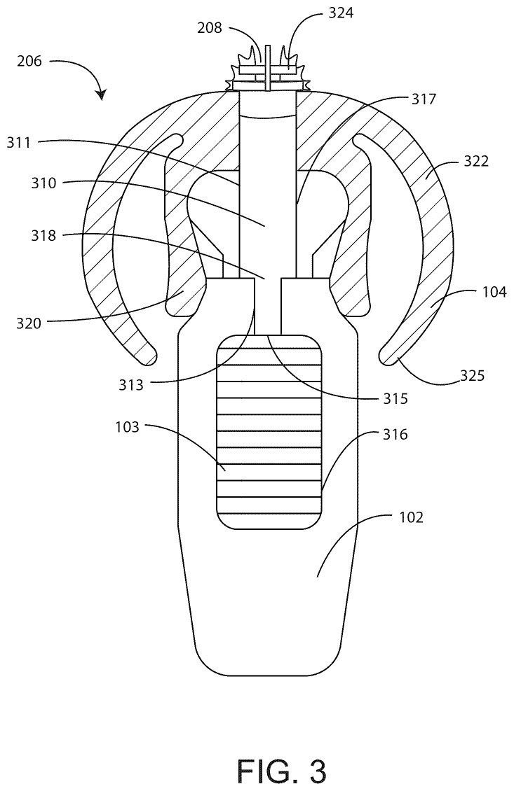

### Receiver Assembly (FIGS. 2-3)

Referring now to FIG. 2, a perspective view of a receiver assembly and earbud is shown in accordance with various embodiments herein. In various embodiments, an ear-wearable device (such as the ear-wearable device 100 of FIG. 1) can include a receiver assembly 206. The receiver assembly can be connected to an earbud 104. In various embodiments, the earbud 104 is configured to be removably attachable to the receiver assembly 206. The removable attachability of the earbud 104 from the receiver assembly 206 facilitates easy cleaning and replacement of the earbud 104. In various embodiments, the receiver assembly 206 can include a receiver housing 102 and a receiver 103 configured to fit within the receiver housing 102.

Referring now to FIG. 3, a cross-sectional view of the receiver assembly and earbud of FIG. 2 about section 3-3, is shown in accordance with various embodiments herein. In various embodiments, the receiver assembly can include a receiver 103 disposed within a housing cavity 316 of the receiver housing 102. A receiver, as defined herein, is any device that is configured to convert electrical signals into sounds, such as an electroacoustic transducer, speaker, loudspeaker, or the like. In the context of ear-wearable devices, one or more microphones gather acoustic energy (sound) from the surrounding environment and convert the acoustic energy into electrical signals. In some embodiments, the electrical signals are then transmitted to an amplifier which increases the amplitude of the electric signals. The amplified electric signals are then transmitted to the receiver 103, which converts the received electric signals into sounds. The sounds are then transmitted to a user's ear via an acoustic outlet at the device opening 208 of the ear-wearable device 100. Any suitable type or types of receiver can be used in the ear-wearable device 100 including, but not limited to armature receivers, moving coil receivers, or the like.

In the example of FIG. 3, sounds generated by the receiver 103 within the receiver housing 102 travels through an acoustic channel 310 that is defined by the receiver housing 102 and the earbud 104 and exits the receiver assembly 206 at a device opening 208 of the earbud 104. In various embodiments, the acoustic channel 310 can define an acoustic channel wall 311. In the example of FIG. 3, a first portion of the acoustic channel wall 311 is formed by an inner surface 313 of the receiver housing 102. The first portion of the acoustic channel wall 311 can be defined between the receiver outlet 315 and a receiver opening 318 of the receiver housing 102. In the example of FIG. 3, a second portion of the acoustic channel wall 311 is formed by an inner surface 317 of the earbud 104. The second portion of the acoustic channel wall 311 can be defined between the receiver opening 318 and the device opening 208 of the earbud 104.

In various embodiments, the earbud 104 includes an axial wall 320 that surrounds a portion of the receiver housing 102 when the earbud 104 is placed over a portion of the receiver housing 102. The axial wall 320 defines and surrounds at least a portion of the acoustic channel 310. In various embodiments, the earbud 104 also includes an outer dome 322. The outer dome can be connected to the axial wall 320 adjacent to the device opening 208 of the earbud 104. In some embodiments, the outer dome 322 can be unconnected to the axial wall 320 at free end 325 to enhance the compliant fit of the earbud 104.

In various embodiments, the earbud 104 is made from a material and constructed so that it conforms to the ear canal and maintains a constant and comfortable radial pressure on the ear canal. In various examples, the earbud 104 is made of resilient material, such as silicone. In various examples, the earbud 104 is made of a flexible material. By flexible material, it is meant that a material is capable of bending easily without breaking. In various examples, the earbud is made of an elastomeric material. By “elastomeric material,” it is meant a material with viscoelasticity that is soft and deformable at ambient temperatures, such as rubber, silicone, and amorphous polymers. The flexibility and resilience of the material facilitates a seal of the earbud 104 to the receiver housing 102 over the acoustic channel 310.

In various embodiments, the device opening 208 can provide an entry point for foreign matter into the ear-wearable device. Foreign matter as defined herein is any matter other than air that can enter the ear-wearable device and can include skin cells, dust, body oil, food, hairspray, ear wax, water, or the like. Performance of the audio components placed in ear canal (e.g., the receiver 103) tend to suffer when foreign matter plugs the acoustic ports (e.g., acoustic channel 310). In severe cases, foreign matter can collect on the acoustic channel wall 311 to the point that the acoustic channel 310 is almost entirely obstructed, resulting in dramatic change in acoustic impedance and effective reduction of device output. For this reason, ear worn devices often come with occlusion domes and protective grids for receivers that regular cleaning and replacement.

In various embodiments, the receiver assembly 206 can include an acoustic port guard 324 disposed at the device opening 208. The acoustic port guard 324 is configured to block foreign material entering the acoustic channel 310 of the receiver assembly 206.

In various embodiments, the acoustic port guard 324 is positioned in a device opening that is configured to be positioned within the user's ear canal when the ear-wearable device is worn. An ear-wearable device where at least a portion of the device is positioned within the user's ear canal can be referred to as an in-canal device. In various embodiments, the acoustic port guard is positioned in a device opening that is configured to be outside of the ear canal when the ear-wearable device is worn, such as a device opening to a housing of a behind-the-ear device.

In various embodiments, at least a portion of the acoustic port guard 324 is configured to be inserted into the acoustic channel 310 via the device opening 208. In various embodiments, an outer surface of the portion of acoustic port guard 324 that is inserted into the acoustic channel 310 is configured to contact the acoustic channel wall 311. In various embodiments, the contact between the acoustic port guard 324 and the acoustic channel wall 311 is configured keep the acoustic port guard 324 stationary with respect to the receiver assembly 206. In various embodiments, the acoustic port guard 324 is configured to be inserted deep enough into the acoustic channel 310 such that the acoustic port guard 324 has substantially no movement with respect to the receiver assembly 206.

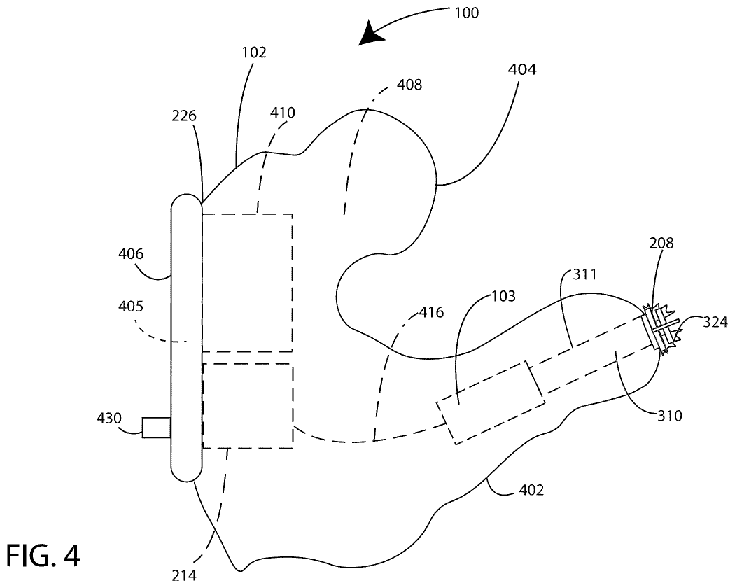

### Alternate Custom Receiver Configuration (FIG. 4)

Referring now to FIG. 4, a schematic view of an in-the-ear style custom ear-wearable device is shown in accordance with various embodiments herein. The ear-wearable device 100 can include an ear-wearable device housing 402 formed by a shell 404 and a faceplate 406. The shell 404 is custom shaped to mate with the user's ear anatomy and defines a shell cavity 408 and a shell aperture 405 at the entrance to the shell cavity 408. The faceplate 406 is attached to the shell at the shell aperture 405 to enclose the shell cavity 408.

The ear-wearable device housing 402 can define a battery compartment 410 in which a battery can be disposed to provide power to the device. The ear-wearable device 100 can also include a receiver 103. The receiver 103 can include a component that converts electrical impulses into sound, such as an electroacoustic transducer, speaker, or loudspeaker. The ear-wearable device housing 402 can also define a component compartment 214 that can contain electrical and other components including, but not limited to, a microphone, a processor, memory, various sensors, one or more communication devices, power management circuitry, and a control circuit. A cable 416 or connecting wire can include one or more electrical conductors and provide electrical communication between components inside of the component compartment 214 and components inside of the receiver 103.

In various embodiments, the shell 404 extends from a device opening 208 to an aperture end 226. At the aperture end 226, the shell 404 defines a shell aperture 405 that is closed by the faceplate 406. The faceplate 406 is sealed to the shell 404. The faceplate 406 is shown in FIG. 4 in a side view but can include many features and structures. A user input device 430 is shown as part of the faceplate in FIG. 4, and can be a button, lever, switch, dial, or other input device. The faceplate 406 may also include a battery door, a microphone opening, a pull handle, and other features.

In various embodiments, sounds generated by the receiver 103 travel through an acoustic channel 310 and exit the ear-wearable device 100 at a device opening 208. In various embodiments, the acoustic channel 310 can have an acoustic channel wall 311. In some embodiments, the acoustic channel wall 311 can be formed from a portion of the ear-wearable device housing 402, such as during a molding process that forms the shell 404. Alternatively, the acoustic channel wall 311 can be formed from a structure separate from the ear-wearable device housing 402, such as one or more tubes inserted and attached to the shell 404. In various embodiments, one or more tubes made from a rubber or elastomer material can be used, such as a tube made from Viton™ fluoroelastomer materials made by The Chemours Company, having a place of business in Wilmington, Delaware, United States.

In various embodiments, the device opening 208 can provide an entry point for foreign material into the ear-wearable device 100. In various embodiments, the ear-wearable device 100 can include an acoustic port guard 324 disposed at the device opening 208. The acoustic port guard 324 is configured to block foreign material entering the acoustic channel 310 of the ear-wearable device 100.

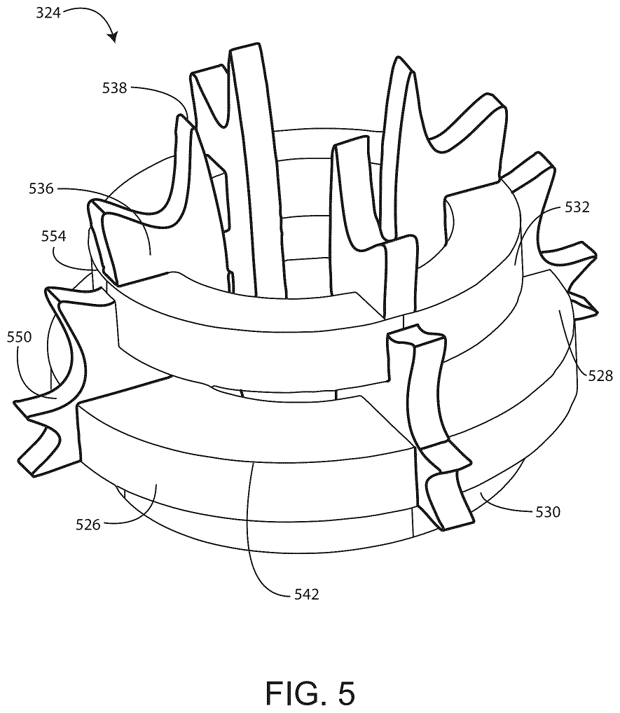

### Acoustic Port Guard (FIGS. 5-7)

Referring now to FIG. 5, a perspective view of an acoustic port guard is shown in accordance with various embodiments herein. The acoustic port guard 324 is configured to be disposed at a device opening such as the device opening 208 of the receiver assembly 206 of FIG. 2 or the device opening 208 of the ear-wearable device 100 of FIG. 4.

In various embodiments, acoustic port guard 324 can include a first ring structure 526. The first ring structure 526 can include a first ring portion 528 and an insertion portion 530. In various embodiments, the insertion portion 530 is configured to be inserted into a device opening 208 of an ear-wearable device 100. In some embodiments, the acoustic port guard 324 can include a second ring structure 532 positioned coaxially with and spaced a fixed distance from the first ring structure 526. In alternate configurations, the acoustic port guard 324 can include a first ring structure 526 without a second ring structure 532.

In various embodiments, the insertion portion 530 of the first ring structure 526 is configured to be inserted into the acoustic channel 310 of an ear-wearable device 100 and a proximal face of the first ring portion 528 is configured to rest on the device opening 208. In various embodiments, the second ring structure 532 is disposed further out from device opening 208 than the first ring structure 526. In various embodiments, the ring structure disposed furthest away from the device opening 208 effectively serves as the acoustic channel inlet when the acoustic port guard 324 is inserted into the ear-wearable device 100. In alternate configurations, the acoustic port guard 324 may have two or more additional ring structures positioned coaxially with and spaced above the first ring structure 526.

In various embodiments, the insertion portion 530 is configured to be inserted into the acoustic channel 310 via the device opening 208. In various embodiments, an outer surface of the insertion portion 530 is configured to contact the acoustic channel wall 311. In various embodiments, the contact between the insertion portion 530 and the acoustic channel wall 311 is configured keep the acoustic port guard 324 stationary with respect to the receiver assembly 206. In various embodiments, the insertion portion 530 is configured to be inserted deep enough into the acoustic channel 310 such that the acoustic port guard 324 has substantially no movement with respect to the receiver assembly 206.

In various embodiments, acoustic port guard 324 can include a plurality of ribs 536. Each of the plurality of ribs 536 can be connected to the first ring structure 526. Each of the plurality of ribs 536 can be connected to the second ring structure 532. The acoustic port guard 324 can include any suitable number of ribs 536. In some embodiments, the number of ribs 536 can be greater than or equal to two, four, six, eight, or ten ribs, or can be an amount equal to or in a range between any of the foregoing.

Each of the plurality of ribs 536 can define a plurality of spiked portions 538. Each rib 536 can define an outer portion 550 configured to extend beyond an outer radius 542 of the first ring structure 526. In various embodiments, the outer portion is configured to extend beyond an outer radius 554 of the second ring structure 532. The outer portion 550 may include one of the plurality of spiked portions 538.

In some embodiments, the spiked portions 538 are narrower and sharper than the bases of their respective ribs 536 but are sufficiently dull, flexible, or both dull and flexible as to not injure or cause discomfort when inserted into the ear canal of a user. Where the ribs have outer portions that are narrower than inner portions, foreign matter, including wax, experiences increasing resistance as it advances toward a center of the acoustic port guard, aiding in keeping the foreign matter away from the open central channel. Alternatively, the spiked portions 538 can have approximately the same thickness as the bases of their respective ribs 536.

In the example of FIG. 5, each of the plurality of ribs 536 has five spiked portions 538. However, each of the plurality of ribs 536 can include any suitable number of spiked portions 538. In some embodiments, the number of spiked portions 538 can be greater than or equal to 2, 4, 6, 8, 10, 12, 14, or 15 spiked portions, or can be an amount falling within a range between any of the foregoing.

In various embodiments, the acoustic port guard 324 is configured to block foreign material entering the acoustic channel 310 of an ear-wearable device 100. As seen in FIGS. 3-4, the acoustic port guard 324 is configured to extend out of the acoustic channel 310 through the device opening 208. Such a configuration can function to intercept foreign material outside of the acoustic channel 310. In various embodiments, the rib structures are flexible, such as an elastomeric material, and configured to facilitate the rib structures being flexed and/or brushed off to free foreign matter. In various embodiments, the rib structures easily shed the foreign matter when the ear-wearable device is moved or shaken, such as when the ear-wearable device is removed from the user's ear.

In various embodiments, the ribs 536 function to connect the first ring structure 526 and second ring structure 532 and provide structural rigidity to the acoustic port guard 324. Additionally, each of the ribs 536 extend above and beyond the first ring structure 526 and the second ring structure 532. In various embodiments, each of the ribs 536 extend away from the first ring structure 526 in a direction away from the insertion portion 530. In various embodiments, each of the ribs 536 extend away from the second ring structure 532 in a direction away from the insertion portion 530 and the first ring structure 526. In the example of FIG. 5, the tips of all the spiked portions 538 of each of the plurality of ribs 536 form points on a virtual spheroidal surface (or more particularly a hemi-spheroidal surface). In various embodiments, the spiked portions 538 function is to prevent foreign material from entering the acoustic channel 310. For instance, the ribs 536 are configured to capture and/or deflect foreign material and keep it at a distance from the acoustic channel 310 of an ear-wearable device 100.

In various embodiments, one or more of the spiked portions has a radius of curvature. In some embodiments, the radius of curvature can be greater than or equal to 0.5 millimeter (mm), 0.6 mm, 0.8 mm, 0.9 mm, 1.0 mm, 1.1 mm, 1.2 mm, 1.4 mm, or 1.5 mm. In some embodiments, the radius of curvature can be less than or equal to 3.0 mm, 2.8 mm, 2.6 mm, 2.4 mm, 2.2 mm, 2.1 mm, 1.9 mm, 1.7 mm, or 1.5 mm. In some embodiments, the radius of curvature can fall within a range of 0.5 mm to 3.0 mm, or 0.6 mm to 2.8 mm, or 0.8 mm to 2.6 mm, or 0.9 mm to 2.4 mm, or 1.0 mm to 2.2 mm, or 1.1 mm to 2.1 mm, or 1.2 mm to 1.9 mm, or 1.4 mm to 1.7 mm, or can be about 1.5 mm.

In various embodiments, rather than entering the acoustic channel 310 of an ear-wearable device 100, the acoustic port guard 324 is configured so that foreign material accumulates on the ribs 536 of the acoustic port guard 324. Due to their geometry and material properties, the ribs 536 of the acoustic port guard 324 have low friction. Consequentially, foreign material that has collected on the acoustic port guard 324 during use tends to fall off (or can be easily removed) from the acoustic port guard 324 when an ear-wearable device 100 is taken out of a user's ear canal.

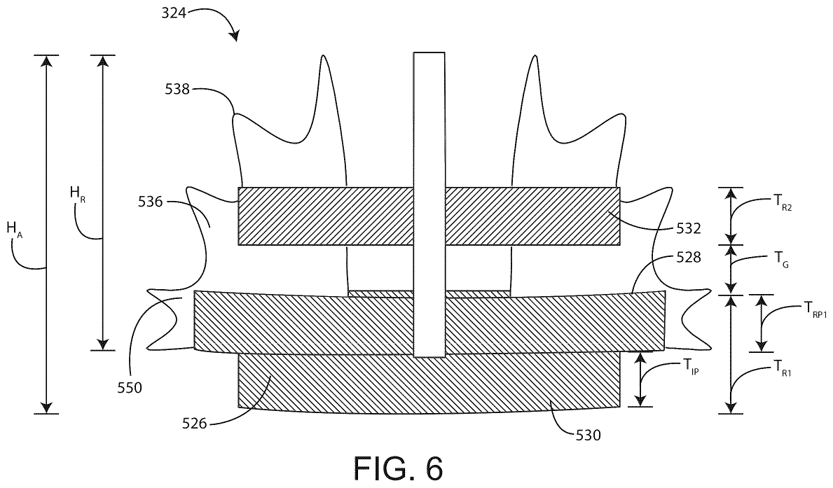

Referring now to FIG. 6, a front view of the acoustic port guard of FIG. 5 is shown in accordance with various embodiments herein. In various embodiments, the acoustic port guard 324 can include a first ring structure 526, a second ring structure 532, and a plurality of ribs 536.

In various embodiments, the acoustic port guard 324 has a total height H_{A}, measured from a first end to a second end. In various embodiments, the first end is at an outside surface of the insertion portion and the second end is at an outside surface of a rib. In some embodiments, the total height H_{A} can be greater than or equal to 0.75 mm, 0.90 mm, 1.10 mm, or 1.25 mm. In some embodiments, the total height H_{A} can be less than or equal to 2.00 mm, 1.75 mm, 1.50 mm, or 1.25 mm. In some embodiments, the total height H_{A} can fall within a range of 0.75 mm to 2.00 mm, or 0.90 mm to 1.75 mm, or 1.10 mm to 1.50 mm, or can be about 1.25 mm.

In various embodiments, each rib 536 of the acoustic port guard has a rib height H_{R}, measured from a surface of the rib closest to a reference plane defining an interface between the insertion portion and the first ring portion, to an end surface of the rib farthest from the reference plane. In some embodiments, the height H_{R} can be greater than or equal to 0.5, 0.7, 0.8, or 1.0 mm. In some embodiments, the height H_{R} can be less than or equal to 1.5, 1.3, 1.2, or 1.0 mm. In some embodiments, the height H_{R} can fall within a range of 0.5 to 1.5 mm, or 0.7 to 1.3 mm, or 0.8 to 1.2 mm, or can be about 1.0 mm. In some embodiments, each of the plurality of ribs 536 is approximately the same height. In some embodiments, the plurality of ribs 536 can have varying heights.

In various embodiments, the insertion portion 530 of the acoustic port guard 324 has a thickness T_{IP}. In some embodiments, the thickness T_{IP} of the insertion portion 530 can be greater than or equal to the rib height H_{R} In some embodiments, the thickness T_{IP} can be greater than or equal to 0.50, 0.58, 0.67, or 0.75 mm. In some embodiments, the thickness T_{IP} can be less than or equal to 3.00, 2.25, 1.50, or 0.75 mm. In some embodiments, the thickness Trp can fall within a range of 0.50 to 3.00 mm, or 0.58 to 2.25 mm, or 0.67 to 1.50 mm, or can be about 0.75 mm.

In various embodiments, the first ring structure 526 of the acoustic port guard 324 has a thickness T_{R1}. In some embodiments, the thickness TR1 can be greater than or equal to 0.25 mm, 0.33 mm, 0.42 mm, or 0.50 mm. In some embodiments, the thickness T_{R1} can be less than or equal to 3.50 mm, 2.50 mm, 1.50 mm, or 0.50 mm. In some embodiments, the thickness T_{R1} can fall within a range of 0.25 mm to 3.50 mm, or 0.33 mm to 2.50 mm, or 0.42 mm to 1.50 mm, or can be about 0.50 mm.

In various embodiments, the first ring portion 528 of the acoustic port guard 324 has a second ring thickness T_{RP1}. In some embodiments, the thickness T_{RP1} can be greater than or equal to 0.1, 0.15, or 0.2 mm. In some embodiments, the thickness T_{RP1} can be less than or equal to 0.5, 0.4, 0.3, or 0.2 mm. In some embodiments, the thickness T_{RP1} can fall within a range of 0.1 to 0.5 mm, or 0.2 to 0.4 mm, or 0.2 to 0.3 mm, or can be about 0.2 mm.

In various embodiments, the second ring structure 532 of the acoustic port guard 324 has a second ring thickness T_{R2}. In some embodiments, the thickness T_{R2} can be greater than or equal to 0.1, 0.15, or 0.2 mm. In some embodiments, the thickness T_{R2} can be less than or equal to 0.5, 0.4, 0.3, or 0.2 mm. In some embodiments, the thickness T_{R2} can fall within a range of 0.1 to 0.5 mm, or 0.2 to 0.4 mm, or 0.2 to 0.3 mm, or can be about 0.2 mm. In various embodiments, the first ring portion 528 of the first ring structure 526 can have approximately the same thickness as the second ring structure 532.

In various embodiments, there is an axial gap between the first ring structure 526 and the second ring structure 532. The axial gap can have a thickness T_{G}. In some embodiments, the thickness T_{G} can be greater than or equal to 0.1, 0.15, or 0.2 mm. In some embodiments, the thickness T_{G} can be less than or equal to 0.5, 0.4, 0.3, or 0.2 mm. In some embodiments, the thickness T_{G} can fall within a range of 0.1 to 0.5 mm, or 0.2 to 0.4 mm, or 0.2 to 0.3 mm, or can be about 0.2 mm.

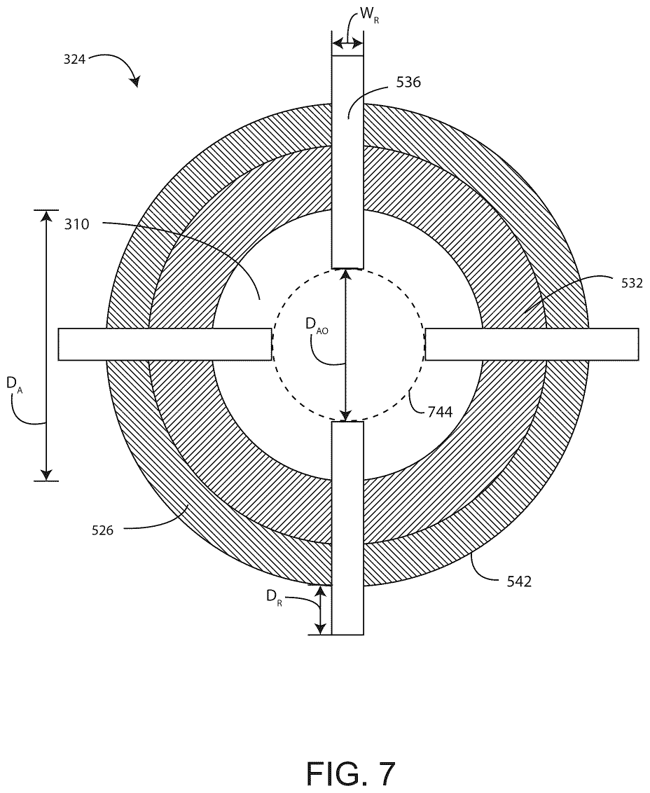

Referring now to FIG. 7, a top view of the acoustic port guard of FIG. 5 is shown in accordance with various embodiments herein. In the example of FIGS. 5-7, the acoustic port guard 324 includes four ribs 536 distributed axially symmetrically about the diameter of the acoustic port guard 324. However, the acoustic port guard may have any suitable number or configuration of ribs 536.

In various embodiments, when inserted into the device opening 208 of an ear-wearable device 100, the first ring structure 526 and second ring structure 532 effectively form a portion of the acoustic channel 310 of the ear-wearable device. In various embodiments, the portion of the acoustic channel defined by the first ring structure 526 and second ring structure 532 has an acoustic channel portion diameter DA. In some embodiments, the diameter DA can be greater than or equal to 0.75 mm, 0.8 mm, 0.9 mm, or 1.0 mm. In some embodiments, the diameter DA can be less than or equal to 1.5 mm, 1.3 mm, 1.2 mm, or 1.0 mm. In some embodiments, the diameter DA can fall within a range of 0.75 mm to 1.5 mm, or 0.8 mm to 1.3 mm, or 0.9 mm to 1.2 mm, or can be about 1.0 mm.

In various embodiments, the plurality of ribs 536 span at least a portion of the acoustic channel 310. In various embodiments, the acoustic port guard 324 defines an open central channel 744. The open central channel 744, as defined herein, is the central portion of the acoustic channel 310 in which the ribs 536 do not extend. In the example of FIG. 7, the open central channel 744 is substantially circular in cross section, however other cross-sectional shapes are possible. In various embodiments, the open central channel has a diameter D_{AO}. In some embodiments, the diameter D_{AO} can be greater than or equal to 0.25, 0.33, 0.42, or 0.50 mm. In some embodiments, the diameter D_{AO} can be less than or equal to 0.75, 0.67, 0.58, or 0.50 mm. In some embodiments, the diameter D_{AO} can fall within a range of 0.25 to 0.75 mm, or 0.33 to 0.67 mm, or 0.42 to 0.58 mm, or can be about 0.50 mm.

In various embodiments, open central channel 744 defines a fraction of the total cross-sectional area of the acoustic channel 310. In some embodiments, the area of the open central channel 744 can be greater than or equal to 15%, 18%, 22%, or 25% of the total cross-sectional area of the acoustic channel 310. In some embodiments, the area of the open central channel 744 can be less than or equal to 50%, 42%, 33%, or 25% of the total cross-sectional area of the acoustic channel 310. In some embodiments, the area of the open central channel 744 can fall within a range of 15% to 50%, or 18% to 42%, or 22% to 33%, or can be about 25% of the total cross-sectional area of the acoustic channel 310.

In various embodiments, the plurality of ribs 536 are configured to extend beyond an outer radius 542 of the first ring structure 526 by a distance D_{R}. In some embodiments, the distance D_{R} can be greater than or equal to 0.05 mm, 0.10 mm, 0.15 mm, or 0.20 mm. In some embodiments, the distance D_{R} can be less than or equal to 0.50 mm, 0.40 mm, 0.30 mm, or 0.20 mm. In some embodiments, the distance D_{R} can fall within a range of 0.05 mm to 0.50 mm, or 0.10 mm to 0.40 mm, or 0.15 mm to 0.30 mm, or can be about 0.20 mm.

In various embodiments, each of the plurality of ribs 536 has a width W_{R}. In some embodiments, the width W_{R} can be greater than or equal to 0.02, 0.05, 0.08, or 0.10 mm. In some embodiments, the width W_{R} can be less than or equal to 0.25, 0.20, 0.15, or 0.10 mm. In some embodiments, the width W_{R} can fall within a range of 0.03 to 0.25 mm, or 0.05 to 0.20 mm, or 0.08 to 0.15 mm, or can be about 0.10 mm. In various embodiments, each of the plurality of ribs 536 has the same width W_{R}. Alternatively, the ribs 536 can have a variety of different widths W_{R}. In the example of FIG. 7, each of the plurality of ribs 536 has an approximately constant width W_{R}. However, it is possible for the width W_{R} of each rib to vary.

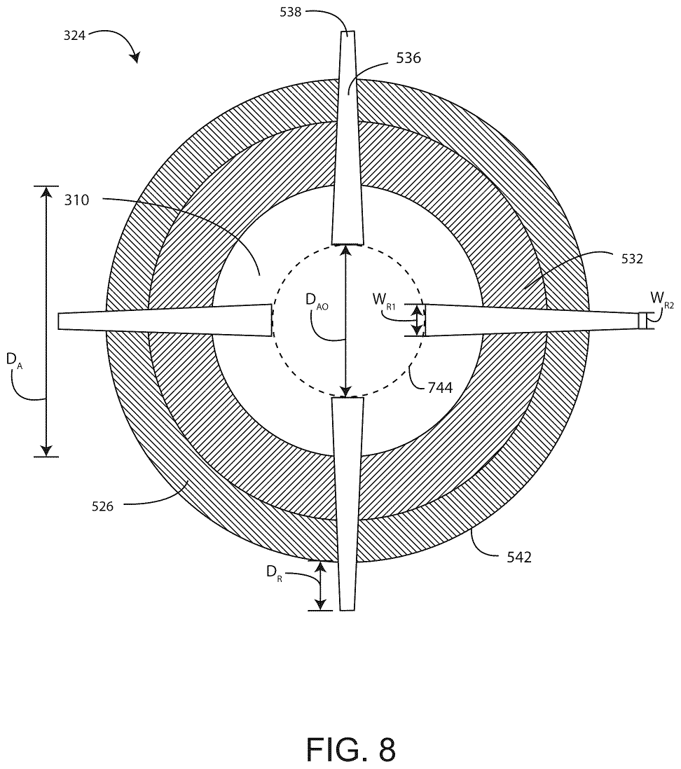

### Ribs of Varying Thickness (FIG. 8)

Referring now to FIG. 8, a top view of an alternate configuration of an acoustic port guard is shown in accordance with various embodiments herein. In various embodiments, the acoustic port guard 324 can include a first ring structure 526, a second ring structure 532, and a plurality of ribs 536. The acoustic port guard of FIG. 8 is substantially similar to the acoustic port guard of FIG. 7, but each of the plurality of ribs 536 has a varying thickness.

In the example of FIG. 8, each rib 536 has a first thickness W_{R1} where the rib terminates at the open central channel 744. Each of the ribs 536 tapers down to a second thickness W_{R2} corresponding to the spiked portion 538 of each rib. In some embodiments, the ratio of the widths W_{R2}/W_{R1} can be greater than or equal to 0.2, 0.4, or 0.5. In some embodiments, the ratio of the widths W_{R2}/W_{R1} can be less than or equal to 0.2, 0.4, or 0.5. In some embodiments, the ratio of the widths W_{R2}/W_{R1} fall within a range of 0.2 to 0.2, or 0.4 to 0.4, or can be about 0.5.

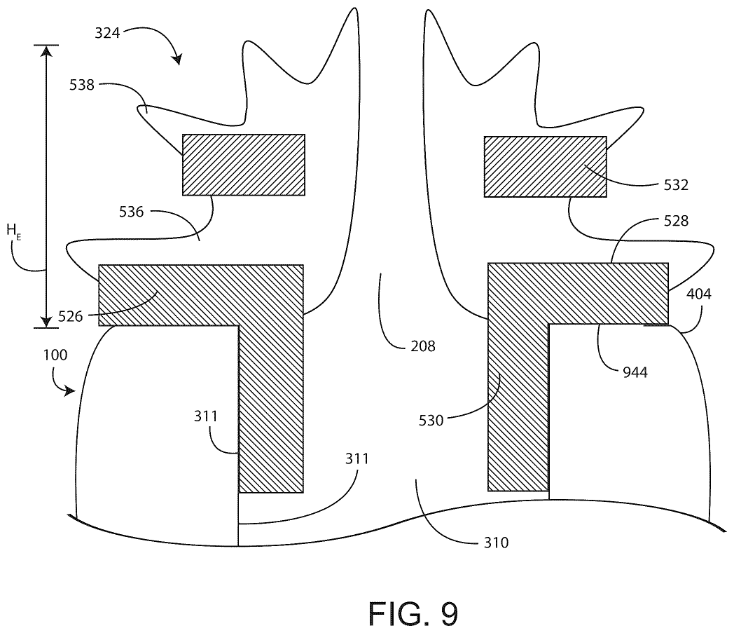

### Acoustic Port Guard Installed in Ear-Wearable Device (FIG. 9)

Referring now to FIG. 9, a cross-sectional view of an acoustic port guard disposed in an ear-wearable device is shown in accordance with various embodiments herein. In various embodiments, the acoustic port guard 324 can include a first ring structure 526, a second ring structure 532, and a plurality of ribs 536. The first ring structure 526 can include a first ring portion 528 and an insertion portion 530. In the example of FIG. 9, the insertion portion 530 of the first ring structure 526 is inserted into the acoustic channel 310 of the ear-wearable device 100 and a proximal face 944 of the first ring portion 528 is configured to rest on the shell 404 of the ear-wearable device surrounding the device opening 208.

In various embodiments, the insertion portion 530 of the acoustic port guard 324 is configured to conform to the acoustic channel wall 311. In various embodiments, the insertion portion 530 is made from a material and constructed so that it uniformly conforms to acoustic channel 310. In such embodiments, the insertion portion 530 can be sized to have an outer diameter that is approximately the diameter of the acoustic channel 310 of the ear-wearable device 100. The insertion portion 530 can be compressed and inserted into the acoustic channel 310 via the device opening 208. Due to the flexibility and resilience of the material, once inserted, the insertion portion 530 will revert to its original shape forming a seal to the acoustic channel wall 311 of the ear-wearable device 100. In such an embodiment, the acoustic port guard can be pulled out from the acoustic channel 310 via the device opening 208 by hand or using an insertion tool, allowing for the acoustic port guard to be easily removed and replaced.

Additionally, or alternatively, the ear-wearable device 100 and/or the acoustic port guard 324 can include one or more retention features configured to prevent the acoustic port guard from moving with respect to the ear-wearable device. The retention features can include any ribs, spikes, or the like.

In various embodiments, the acoustic port guard extends a set height HE above the device opening 208 of the ear-wearable device 100. In some embodiments, the height HE can be greater than or equal to 0.5, 0.7, 0.8, or 1.0 mm. In some embodiments, the height HE can be less than or equal to 2.0, 1.7, 1.3, or 1.0 mm. In some embodiments, the height HE can fall within a range of 0.5 to 2.0 mm, or 0.7 to 1.7 mm, or 0.8 to 1.3 mm, or can be about 1.0 mm. Consequentially, when the acoustic port guard 324 is in inserted into an ear-wearable device 100, it sticks out into the ear canal of the wearer and collects foreign material that could otherwise enter the acoustic channel 310.

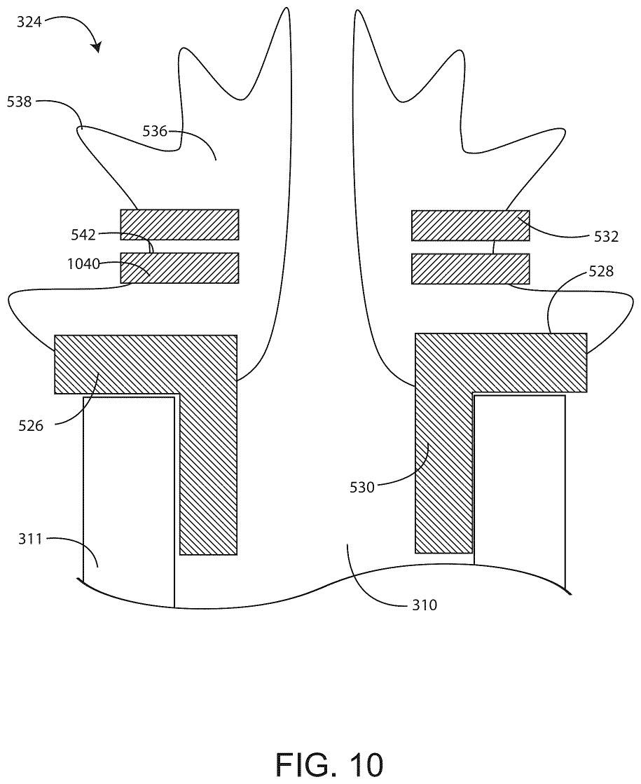

Acoustic Port Guard with Third Ring Structure (FIG. 10)

Referring now to FIG. 10, a cross-sectional view of an alternate configuration of an acoustic port guard is shown in accordance with various embodiments herein, positioned in an acoustic channel of an ear-wearable device. Like the acoustic port guard shown in FIGS. 5-9, the acoustic port guard of FIG. 10 can include a first ring structure 526, a second ring structure 532, and a plurality of ribs 536. However, the acoustic port guard 324 of FIG. 10 further includes a third ring structure 1040. The third ring structure can be disposed between and axially aligned with the first ring structure 526 and the second ring structure 532. In some embodiments, the third ring structure 1040 can enhance structural integrity of the acoustic port guard. It should be noted that the acoustic port guard 324 can include any suitable number of ring structures. In some embodiments, the number of ring structures can be greater than or equal to one, two, three, four, or more ring structures.

### Methods of Using, Making, Installing and Replacing an Acoustic Port Guard

Many different methods are contemplated herein related to an acoustic port guard, including, but not limited to, methods of repelling foreign matter, methods of making, methods of using, methods of installing, methods of replacing, and the like. Aspects of system/device operation described elsewhere herein can be performed as operations of one or more methods in accordance with various embodiments herein.

In an embodiment, a method of repelling foreign material from an ear-wearable device can include providing an acoustic port guard, where the acoustic port guard includes a first ring structure having a first ring portion and an insertion portion and a plurality of ribs connected to the first ring structure, each of the plurality of ribs defining a plurality of spiked portions configured to extend beyond an outer radius of the first ring structure. The method of repelling can further include inserting the insertion portion of the acoustic port guard into an acoustic channel of the ear-wearable device up to a proximal face of the first ring portion, wherein the plurality of ribs blocks foreign material from entering the acoustic channel.

In various embodiments, the acoustic port guard can be freed of foreign matter by shaking the ear-wearable device, flexing the ribs of the acoustic port guard, or both. In various embodiments, a first acoustic port guard can be removed from the ear-wearable device and can be replaced with a second acoustic port guard.

### Acoustic Port Guard Formation, Materials and Coatings

In various embodiments, the acoustic port guard 324 can be formed from any suitable process or processes such as injection molding, additive manufacturing, or the like. In some embodiments, ribs 536 are formed integrally with the first ring structure 526. In some embodiments, the ribs 536 and first ring structure 526 are formed separately and subsequently joined together by any suitable means such as adhesives, or the like.

In some embodiments which include a second ring structure, ribs 536 are formed integrally with the first ring structure 526 and the second ring structure 532. In some embodiments, the ribs 536, first ring structure 526, and the second ring structure 532 are formed separately and subsequently joined together by any suitable means such as adhesives, or the like.

In some embodiments, the acoustic port guard 324 is constructed from a deformable material to provide a comfortable fit within a wearer's ear canal. In various examples, the acoustic port guard 324 can be constructed from any of rubber, silicone, polyethylene, polyurethane, other amorphous polymers, or the like. In some embodiments, the ribs 536, the first ring structure 526, and the optional second ring structure 532 are formed from the same material or materials. In some embodiments, the ribs 536, first ring structure 526, and the optional second ring structure 532 are formed from different materials.

In various embodiments, the acoustic port guard is coated with one or more coatings. The coatings can include any of an omniphobic coating, a hydrophilic coating, an oleophobic coating, a hydrophobic coating, a combination of omniphobic and hydrophilic coatings, or other coating combinations. The coatings can be configured to reduce the unwanted effects of wax, moisture, and other foreign materials. In various embodiments the coating functions to prevent foreign material from sticking to and holding onto the acoustic port guard 324 such that the foreign material tends to fall off (or being easily removed) from the acoustic port guard 324 when an ear-wearable device 100 is taken out of a user's ear canal.

In various embodiments, a coating is provided over the entire acoustic port guard. In various embodiments, different coatings are used on different portions of the acoustic port guard. In various embodiments, outer portions of the acoustic port guard can be provided with a first coating on outer portions of the acoustic port guard and a second, different coating or no coating on inner portions of the acoustic port guard. Examples of outer portions include outer and side surfaces of the ribs. Examples of inner portions include the inner surface of the rings and inner surfaces of the ribs.

In various embodiments, the first coating can include any of an omniphobic coating, a hydrophilic coating, an oleophobic coating, a hydrophobic coating, a combination of omniphobic and hydrophilic coatings, or other coating combinations. In various embodiments, the second coating can include any of an omniphobic coating, a hydrophilic coating, an oleophobic coating, a hydrophobic coating, a combination of omniphobic and hydrophilic coatings, or other coating combinations.

In various embodiments, an oleophobic coating can be used on outer portions of the acoustic port guard, so that ear wax and debris slide easily off of the guard, reducing clogging of the guard. In various embodiments, inner portions of the guard do not include an oleophobic coating, so that foreign matter is not assisted with sliding deeper into the guard structure.

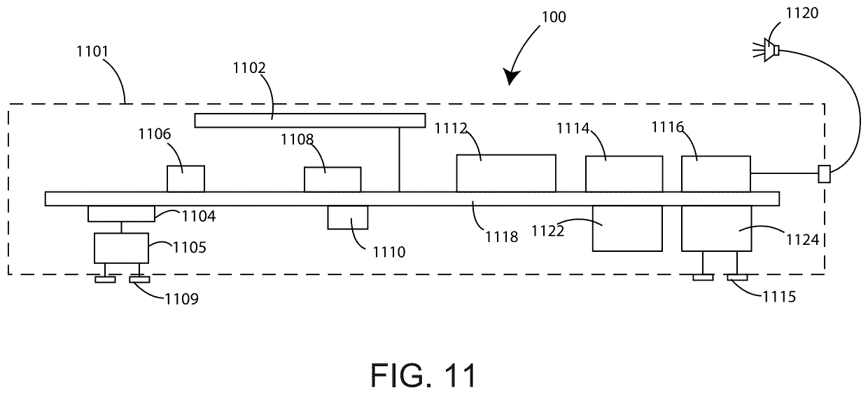

### Ear-Wearable Device Components (FIG. 11)

Referring now to FIG. 11, a schematic block diagram of an ear-wearable device is shown with various components of an ear-wearable device in accordance with various embodiments herein. The block diagram of FIG. 11 represents a generic ear-wearable device for purposes of illustration. It will be appreciated that ear-wearable devices herein can include a greater or lesser number of components than that shown in FIG. 11. The ear-wearable device 110 shown in FIG. 11 includes several components electrically connected to a circuit board 1118, such as a flexible circuit board, which is disposed within housing 1101. A power supply circuit 1104 can include a battery 1105 and can be electrically connected to the circuit board 1118 and provides power to the various components of the ear-wearable device 110. In some examples, the power supply circuit 1104 can include power supply that is different than a battery and which is electrically connected to the circuit board 1118 and provides power to the various components of the ear-wearable device 110. In some embodiments the battery 1105 is rechargeable and can be charged via ear-wearable device charging contacts 1109.

One or more microphones 1106 are operatively connected to the circuit board 1118, which provides electrical communication between the microphones 1106 and a digital signal processor (DSP) 1112. Among other components, the DSP 1112 incorporates or is coupled to audio signal processing circuitry configured to implement various functions described herein. A sensor package 1114 can be coupled to the DSP 1112 via the circuit board 1118. The sensor package 1114 can include one or more different specific types of sensors. One or more user switches 1110 (e.g., on/off, volume, mic directional settings) can be operatively coupled to the DSP 1112 via the circuit board 1118.

An audio output device 1116 is operatively connected to the DSP 1112 via the circuit board 1118. In some embodiments, the audio output device 1116 comprises a speaker (coupled to an amplifier). In other embodiments, the audio output device 1116 comprises an amplifier coupled to an external receiver 1120 adapted for positioning within an ear of a wearer. The external receiver 1120 can include an electroacoustic transducer, speaker, or loudspeaker. The ear-wearable device 110 may incorporate a wireless communication component 1108 coupled to the circuit board 1118 and to an antenna 1102 directly or indirectly via the circuit board 1118. The wireless communication component 1108 can be a BLUETOOTH® transceiver, such as a BLE (BLUETOOTH® low energy) transceiver or other transceiver (e.g., an IEEE 802.11 compliant device).

In various embodiments, the ear-wearable device 110 can also include a control circuit 1124 and a memory storage device 1122. The control circuit 1124 can be in electrical communication with other components of the device. The control circuit 1124 can execute various operations, such as those described herein. In some embodiments, the control circuit 1124 is electrically connected to the input device 1115, such that the control circuit can process signals generated by the suer input. Control circuit 1124 can include various components including, but not limited to, a microprocessor, a microcontroller, an FPGA (field-programmable gate array) processing device, an ASIC (application specific integrated circuit), or the like. The memory storage device 1122 can include both volatile and non-volatile memory. The memory storage device 1122 can include ROM, RAM, flash memory, EEPROM, SSD devices, NAND chips, and the like. The memory storage device 1122 can be used to store data from sensors as described herein and/or processed data generated using data from sensors as described herein.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed, and arranged, constructed, manufactured, and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

The claims:

1. An ear-wearable device comprising:
a receiver;
an acoustic channel wall defining an acoustic channel between the receiver and an acoustic channel opening;
an acoustic port guard disposed at a device opening, the acoustic port guard comprising:
a first ring structure comprising a first ring portion and an insertion portion, wherein the insertion portion is configured to be inserted into the device opening;
a plurality of ribs connected to the first ring structure, each of the plurality of ribs defining an outer portion extending beyond an outer radius of the first ring structure.

2. The ear-wearable device of claim 1, the acoustic port guard comprising a second ring structure.

3. The ear-wearable device of claim 2, wherein the plurality of ribs connects the first ring structure to the second ring structure, and wherein the second ring structure is positioned coaxially to the first ring structure.

4. The ear-wearable device of claim 3, wherein the second ring structure is spaced a fixed axial distance from the first ring structure.

5. The ear-wearable device of claim 2, comprising a third ring structure disposed between the first ring structure and the second ring structure.

6. The ear-wearable device of claim 1, wherein the insertion portion is configured to be inserted into the acoustic channel up to a proximal face of the first ring portion.

7. The ear-wearable device of claim 1, wherein each of the plurality of ribs defines a plurality of spiked portions.

8. The ear-wearable device of claim 7, wherein the outer portion includes at least one of the plurality of spiked portions.

9. The ear-wearable device of claim 1, wherein the acoustic port guard comprises at least three and at most eight ribs.

10. The ear-wearable device of claim 1, wherein the acoustic port guard defines an open central channel, wherein the open central channel defines at least 20% of a cross-sectional area of the acoustic channel.

11. The ear-wearable device of claim 1, the acoustic port guard comprising one of the group consisting of an oleophobic coating, a hydrophilic coating, and a hydrophobic coating.

12. The ear-wearable device of claim 1, wherein the insertion portion is configured to conform to the acoustic channel wall.

13. The ear-wearable device of claim 1, further comprising:
a housing, wherein a housing acoustic channel wall defines at least a housing portion of the acoustic channel, wherein the housing encloses the receiver, and
an earbud configured to fit over at least a portion of the housing, the earbud comprising an earbud inner wall, wherein the earbud inner wall defines an earbud portion of the acoustic channel, wherein the device opening is defined in the earbud at a distal end of the earbud portion of the acoustic channel.

14. The ear-wearable device of claim 1, wherein each of the plurality of ribs extend above the insertion portion by a rib height, wherein the rib height is 0.5 millimeter or greater.

15. An acoustic port guard for an ear-wearable device comprising:
a first ring structure comprising a first ring portion and an insertion portion, wherein the insertion portion is configured to be inserted into an acoustic channel of the ear-wearable device through a device opening of the ear-wearable device;
a second ring structure comprising a second ring portion, wherein the second ring portion defines an acoustic channel opening of the ear-wearable device;
a plurality of ribs connected to the first ring structure and the second ring structure, each of the plurality of ribs defining an outer portion extending beyond an outer radius of the first ring structure and the second ring structure.

16. The acoustic port guard of claim 15, wherein the second ring structure is spaced a fixed axial distance from the first ring structure.

17. The acoustic port guard of claim 15, wherein the insertion portion is configured to be inserted into the acoustic channel up to a proximal face of the first ring portion.

18. The acoustic port guard of claim 15, wherein each of the plurality of ribs defines a plurality of spiked portions.

19. The acoustic port guard of claim 15, wherein the acoustic port guard defines an open central channel, wherein the open central channel defines at least 20% of a cross-sectional area of the acoustic channel.

20. A method of repelling foreign material from an ear-wearable device comprising
i. providing an acoustic port guard, the acoustic port guard comprising:
a first ring structure comprising a first ring portion and an insertion portion; and
a plurality of ribs connected to the first ring structure, each of the plurality of ribs defining a plurality of spiked portions configured to extend beyond an outer radius of the first ring structure; and
ii. inserting the insertion portion of the acoustic port guard into an acoustic channel of the ear-wearable device up to a proximal face of the first ring portion, wherein the plurality of ribs blocks foreign material from entering the acoustic channel.
